(19) United States
(12) Patent Application Publication
(10) Pub. No.: US 2011/0156868 A1
(43) Pub. Date: Jun. 30, 2011

(54) SYSTEM UND VERFAHREN ZUR AUTOMATISIERTEN ANALYSE EINES WETTKAMPFVERLAUFES

(76) Inventors: Florian Hoeflinger, Munchen (DE); Thorsten Habel, Walzbachtal (DE); Mirko Janetzke, Muenchen (DE); Oliver Braun, Karlsbad (DE); Walter Englert, Burgrieden (DE); Christian Holzer, Muenchen (DE)

(21) Appl. No.: 12/996,601

(22) PCT Filed: Jun. 4, 2009
(86) PCT No.: PCT/EP2009/004011

§ 371 Date: Mar. 10, 2011

(30) Foreign Application Priority Data
Jun. 6, 2008 (DE) 10 2008 027 103.9

(51) Int. Cl. G08B 5/22

(52) U.S. Cl. 340/8.1

(57) ABSTRACT

System, consisting of at least one active or passive position detection system which sends data about the position of at least one athlete to a central evaluation unit; and a central evaluation unit which stores received positional data in a database, automatically calculates a movement pattern consisting of at least the covered distance and the mean velocity from the positional data, and represents the movement pattern on a display.

The present invention relates to a system and a method for the automated analysis of the movements and interactions of several athletes and sports equipment by means of several active and passive position detection systems.

In professional as well as in mass sports, modern, preferably imaging technology is employed for the analysis of a competition or training.

The evaluation of the graphical material permits to determine the performance of an athlete, such as e.g. the run distance covered by him or his velocity, where video tracking is usually used for velocity evaluation. It is furthermore possible to obtain hints for future training focuses that should be reasonably employed from the gathered data.

In case of team sports, such as for example soccer or basketball, video recordings are also employed for analyzing movement patterns of an opposing team, for example in a counterattack, and for gearing the own game strategy to it.

Furthermore, in case of team sports, such as ice hockey, recorded video sequences can be used for evaluating controversial game situations, such as fouls or unclear goal situations.

In running sports or swimming, the recorded videos are preferably employed for the analysis and optimization of movement sequences.

Disadvantages of the video recordings used today are their susceptibility to concealing as well as in view of the image quality in rapidly changing light conditions. Moreover, many systems known up to now do not supply any precise velocity and acceleration information and have problems with the automation of the evaluation process.

For example, the question of whether a goal has been scored can only be decided if the view to the ball is free and ensured from a certain angle to the goal line. Furthermore, just in complex scenarios where several persons approach each other or where very fast movements arise, the automated evaluation of video sequences is often faulty as it can happen that persons can no longer be resolved and thus confusions can occur.

It is therefore the object of the present invention to determine the position of one or several athletes more precisely.

Another object of the present invention is to determine the movement of an athlete more precisely.

Another object of the present invention is to determine the position of a piece of sports equipment more precisely.

Another object of the present invention is to determine the interaction between the athlete and the piece of sports equipment more precisely.

Another object of the present invention is to determine recommendations for future training sessions from the data about the movement of an athlete.

Another object of the present invention is to determine recommendations for future training sessions from the data about the interaction between the athlete and a piece of sports equipment.

Another object of the present invention is to design a computer game more realistically and interactively by highly precise data about the movement of an athlete and the interaction between an athlete and a piece of sports equipment.

These objects are achieved by the subject matters of the independent claims.

Preferred embodiments are the subject matter of the depending claims.

The present invention solves these problems by the fusion of data of various sensors and signal transmitters attached to the athlete, sports venue and the piece of sports equipment, whereby the automated evaluation of the athlete's movements and the course of the game is permitted. The obtained data can then be represented virtually, similar to a computer game, where additional performance data can be represented via different menu items.

In the following, preferred embodiments will be illustrated more in detail with reference to the enclosed drawings. In the drawings:

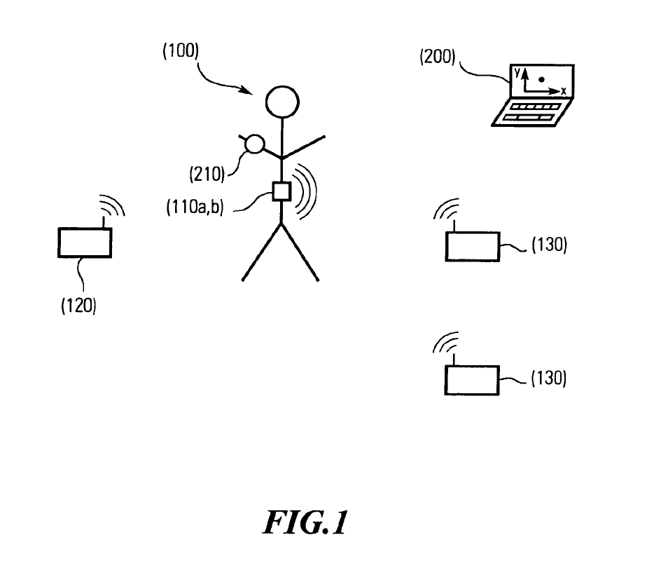

FIG. 1 shows a schematic representation of active and passive position detection systems and associated evaluation units carried along and central evaluation units according to a preferred embodiment of the present invention;

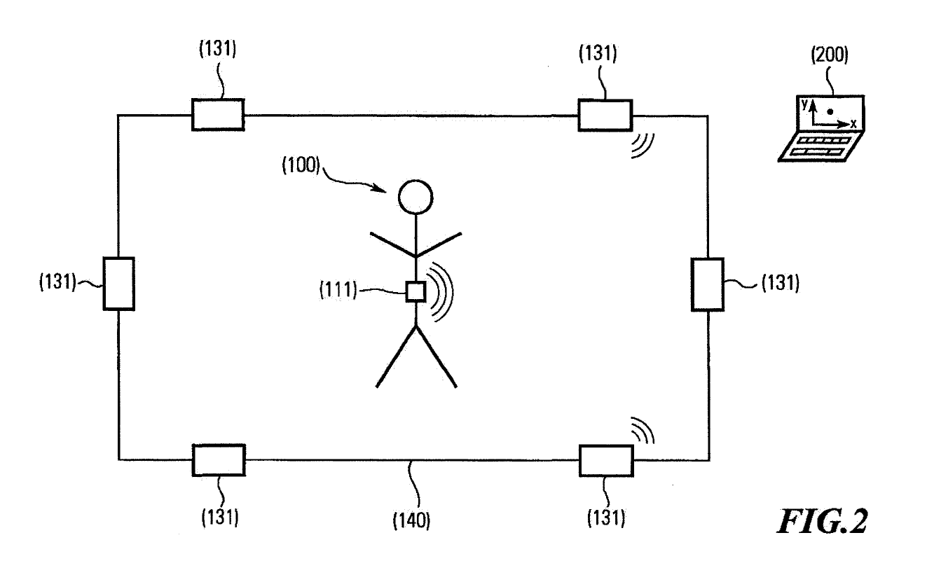

FIG. 2 shows a schematic representation of a sports venue equipped with a passive position detection system according to a preferred embodiment of the present invention;

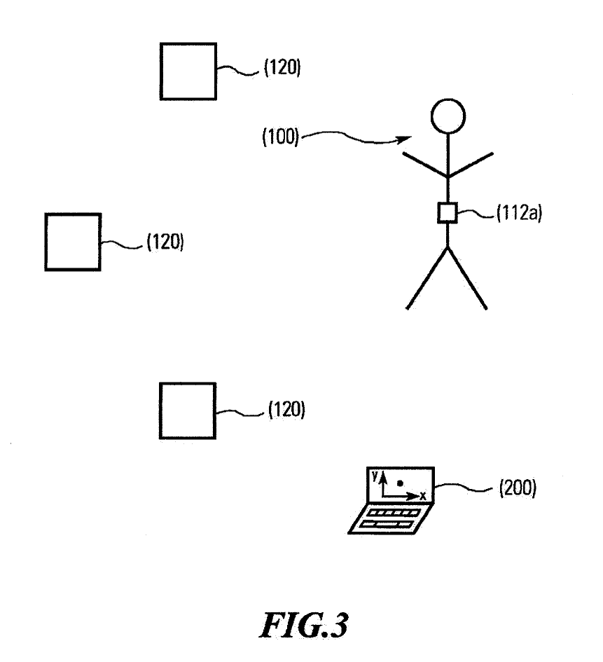

FIG. 3 shows a schematic representation of a sports venue equipped with an active position detection system according to a preferred embodiment of the present invention;

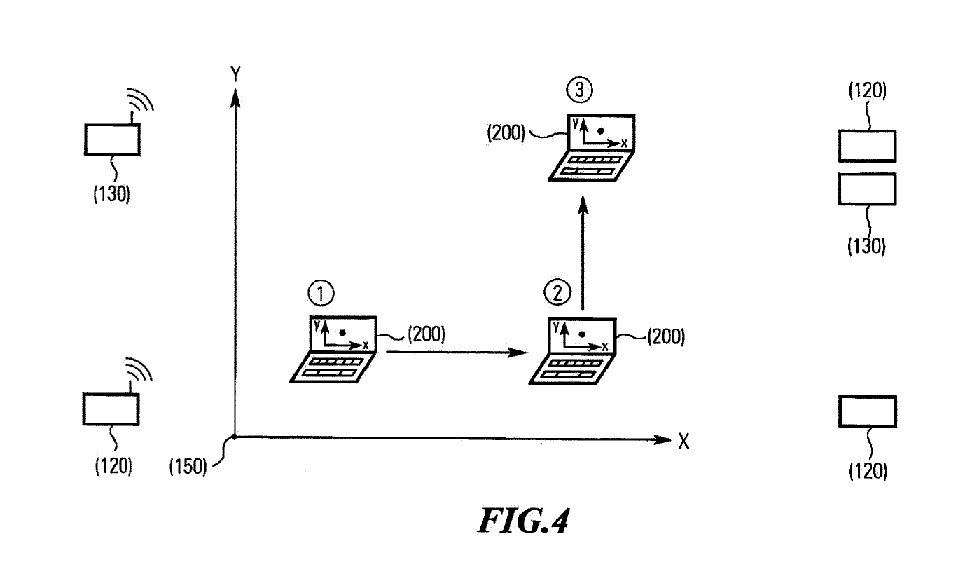

FIG. 4 shows a schematic representation concerning the principle showing how a transmitter and a receiver can be calibrated according to a preferred embodiment of the present invention;

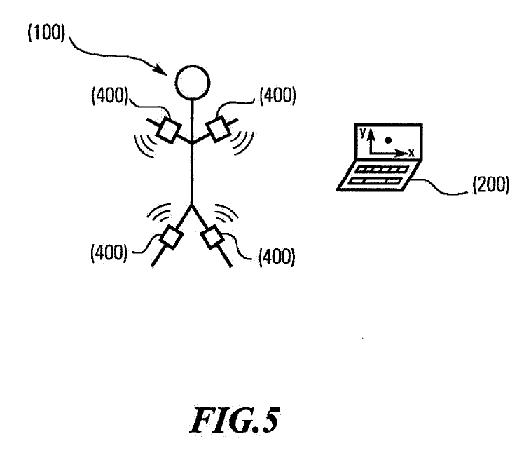

FIG. 5 shows a schematic representation of an athlete equipped with acceleration sensors according to a preferred embodiment of the present invention;

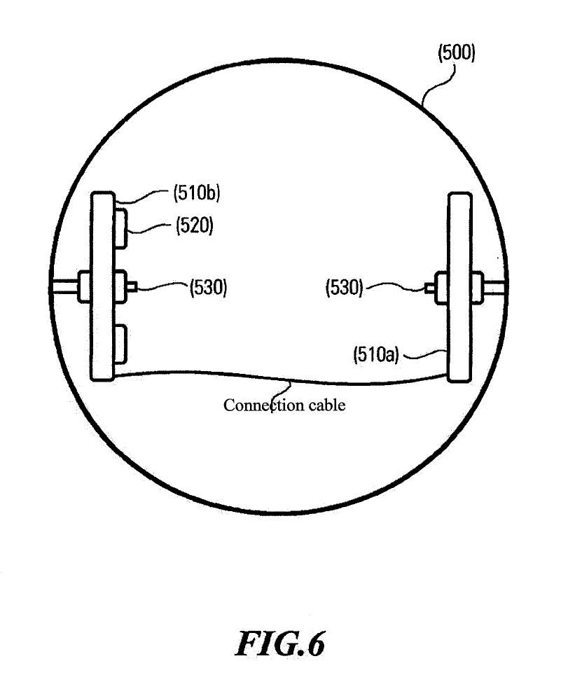

FIG. 6 shows a schematic representation of a ball with two three-dimensional magnetic field sensors according to a preferred embodiment of the present invention; and

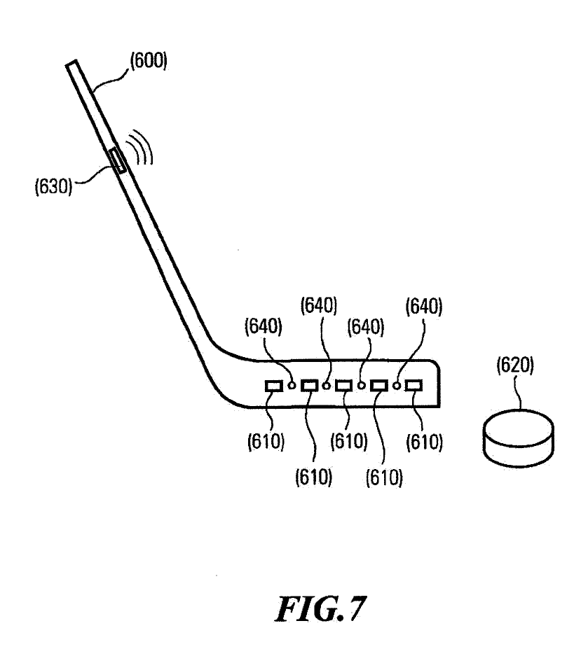

FIG. 7 shows a schematic representation of a piece of sports equipment with pressure sensors according to a preferred embodiment of the present invention; and

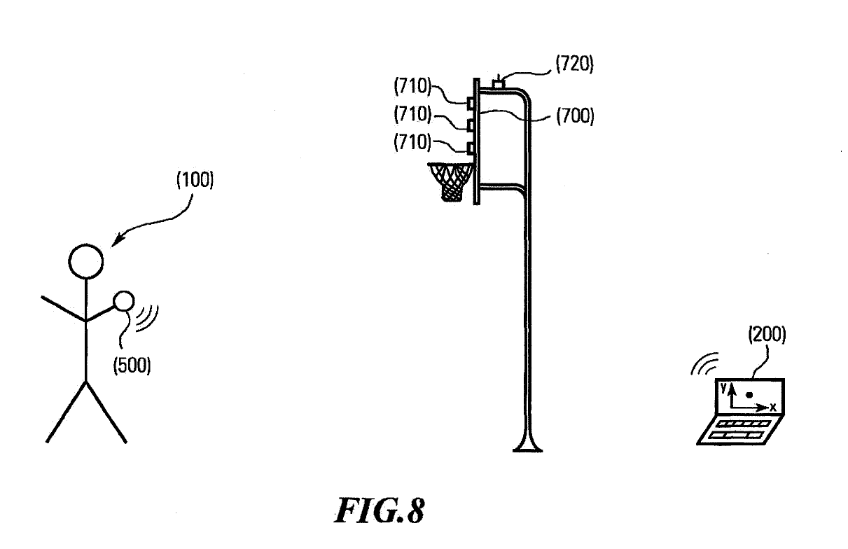

FIG. 8 shows a schematic representation of a piece of sports equipment with the indication of an area to be hit according to a preferred embodiment of the present invention; and

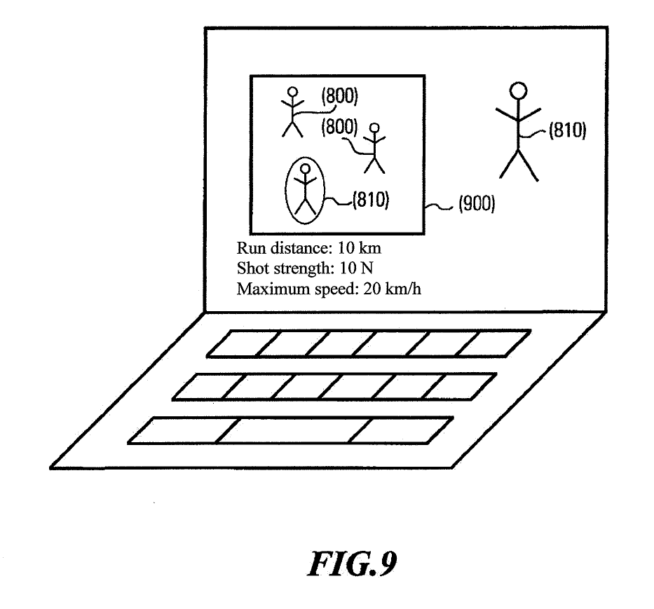

FIG. 9 shows a schematic representation of a display on a central evaluation unit according to a preferred embodiment of the present invention.

FIG. 1 shows a schematic representation of active and passive position detection systems and associated evaluation units carried along as well as central evaluation units according to a preferred embodiment of the present invention.

Here, an athlete (100) is equipped with one or a combination of several passive or active position detection systems (110).

The passive position detection systems (110a) consist of one or several receivers, each receiver being connected to the athlete (100). The receivers receive signals from one or several transmitters (120) that are stationary during the measuring procedure. The receivers forward the received signals to a central evaluation unit (200) which calculates the position of the athlete (100) from the received signals. As an alternative to the transmission to the central evaluation unit (200), the received signals can be locally stored, evaluated and/or displayed on an evaluation unit (210) carried along.

The active position detection systems (110b) consist of one or several transmitters, each transmitter being connected to the athlete (100). Each transmitter emits signals which are received by several stationary receivers (130) and forwarded to the central evaluation unit (200).

If several position detection systems are used, the positioning data are associated and fused in the central evaluation unit (200), for example by means of a Kalman filter.

The power supply of the non-stationary system components is preferably accomplished by means of a battery or accumulator. If passive transponders are employed, a separate source of energy can be dispensed with.

The central evaluation units or the evaluation units carried along are adapted to evaluate, display and store the received data. Furthermore, the data can be forwarded to other units via radio or cable connection, or any other type of transmission. Preferably, radio transmission is effected via WLAN, and cable-based transmission via USB. It is thereby possible to establish an Internet connection, to send the existing data per E-mail, to make them available to other parties as Web Cast Event, or to transmit them via mini USB cable to a PDA or a mobile phone.

FIG. 2 shows a schematic representation of a sports venue equipped with a passive position detection system according to a preferred embodiment of the present invention.

Here, an athlete (100) is equipped with an ultrasonic transmitter (111). The ultrasonic transmitter (111) emits ultrasonic waves of a certain sound intensity for a predetermined time. To prevent several ultrasonic transmitters from continuously interfering with each other, the transmitting times are selected arbitrarily.

The ultrasonic waves are received by ultrasonic sensors (131) installed on the sidelines. To be able to clearly assign the measured values to the athlete (100), the ultrasonic transmitters (111) either transmit on a certain frequency or in pulsed operation, permitting the coded transmission of an identification.

The sound intensity and identification are subsequently forwarded to a central evaluation unit (200) or discarded if the ultrasonic waves of several ultrasonic transmitters have superposed. If the measured sound intensity of an ultrasonic transmitter (111) can be associated to an athlete, it is possible to determine the distance between the ultrasonic transmitter (111) and the ultrasonic sensor (131) from the known interrelationship between the sound wave propagation and the decrease in the sound intensity in the radial direction.

If the ultrasonic sensors (131) are located on the sidelines (140) and the athlete (100) in the playing field, and if the positions of the ultrasonic sensors (131) are known, the position of the athlete (100) can already be determined from the sound intensity measured by two ultrasonic sensors if the distance circles around the sensors only intersect once within the playing field. If the assignment of at least three measured values is successful, the position of the athlete (100) can be determined independent of the playing field.

As ultrasonic waves only have a small range, the athlete can be additionally equipped with a light source emitting infrared light, for example in the form of a light-emitting diode (LED). To avoid superimpositions, the LED begins to emit infrared light of a specific luminous intensity at arbitrary points in time. In the process, the transmission interval and the frequency of recurrence are preferably selected depending on the number of LEDs such that at least two measured values per 0.1 s on average can be received without interference.

The luminous intensity is detected by several infrared light sensors that are, for example, distributed at the side of the sports venue. If no overlap of the transmission times of two or several sources of infrared light occurs, the measured values are forwarded to the central evaluation unit.

To be able to unambiguously assign the transmitted measured values to a source of infrared light, either pulsed infrared light is used and a coded identification emitted, or infrared light of a specific wavelength is used. The position detection of the athlete is then analogous to the method described above for the position detection with ultrasonic sensors.

As the position finding by means of a light source can be subjected to disturbances, such as e.g. concealing or superimposition of different light frequencies, the athlete can be additionally equipped with a GPS receiver. This GPS receiver can send the received positional data as well as an unambiguous identification number either to the central evaluation unit or to an evaluation unit carried along.

Upon reception of a request signal, the evaluation unit carried along sends the stored positional data to the central evaluation unit or permits the central evaluation unit to directly access the data, preferably via USB or WLAN.

As the update rate of a GPS receiver for fast movements can be too low and the GPS signal is not available in closed rooms, the position can be derived from the measurement of a known magnetic field.

FIG. 3 shows a schematic representation of a sports venue equipped with an active position detection system according to a preferred embodiment of the present invention.

Here, an athlete (100) is equipped with a three-dimensional magnetic field sensor (112). The latter measures an alternating magnetic field generated by several coils (120).

Here, a coil is preferably used for measuring the magnetic lines of force. As an alternative, however, a Hall sensor, a magneto-resistive sensor, a Josephson contact, or the like can be also used.

The measured values are sent to the central evaluation unit (200) or the evaluation unit (210) carried along. If the measured values are sent to the central evaluation unit, the time of reception and an unambiguous identification are added which permit the evaluation unit to unambiguously assign the received measured values to a coil and a magnetic field sensor.

The identification of a coil is determined, with the simultaneous operation of all coils, via the measured frequency of the alternating magnetic field, or in case of sequential operation via the point in time of the measurement, where the duration of power supply to the coils and the sequence in which the coils are supplied with power are known. In a simultaneous operation of the coils, the measured signals are either separated by a band-pass filter or by Fourier analysis.

One possibility of detecting the position of the athlete is to compare the field strength, the field direction and the phase position of the magnetic field with previously stored data. Here, the field strength, field direction and phase position are calculated in advance for a plurality of space points and stored in a database on the evaluation unit carried along or the central evaluation unit. The measured values are then compared with the values in the database, and subsequently, the data record matching best is selected. The position assigned to this data record is used as position of the athlete.

As an alternative, the position detection can be determined from the known interrelationship between the propagation of a magnetic field and the radial decrease of the magnetizing force corresponding to the distance of the athlete to each magnetic field coil. The position detection is then accomplished analogously to the position detection with ultrasonic sensors.

Another option is to determine the position by formulating and solving the magnetic field equations.

If ferromagnetic materials or electric cables interfere with the field geometry, the field geometry is measured, and the interferences detected in the process can then be taken into consideration in the position detection.

If several passive or active position detection systems are operated in parallel, it can happen that the data transmission of a first position detection system to the central evaluation unit is interfered by the data transmission of a second position detection system. Therefore, the data of the position detection systems are transmitted at arbitrary points in time, so that no permanent interference of the transmission is to be expected.

As an alternative to this, the measured values are intermediately stored on the evaluation unit carried along and transmitted to the central evaluation unit later. For communication between the active or passive position detection systems and the evaluation unit carried along or the central evaluation unit, in particular 2.4-GHz band radio signals are possible.

The radio signals can moreover also be used for detecting the positions of the stationary transmitters or receivers relative to each other. In the process, analogously to the formerly described methods, the radio signal strength of all sensors stationary during the measuring procedure are measured by the central evaluation unit. This measuring procedure is carried out at least three different places.

FIG. 4 shows a schematic representation concerning the principle showing how a transmitter and a receiver can be calibrated according to a preferred embodiment of the present invention.

Here, a central evaluation unit (200) is operated in a calibration mode and measures the radio strength of the stationary transmitters (120) or receivers (130), respectively, at three different positions, and calculates from these the relative positions of the transmitters or the receivers, respectively, with respect to each other. After a coordinate origin (150) has been determined, all positional data can be displayed in this coordinate system.

If GPS positional data are available, a global coordinate system, for example WGS84, can also be used.

If a video camera is present, the positional data can be used for controlling the same automatically by means of electric motors attached between the camera stand and the camera, such that a certain area of the sports venue can be seen in the camera image. For this, the position of the camera to the sports venue must be known, which is preferably done analogously to the above-described position detection of the sensors and the receivers. Then, the orientation of the camera is determined by aiming at a fixed point which preferably is the already known position of a transmitter or a receiver. From this interrelationship, the camera can be directed to any arbitrary point by determining the horizontal and vertical deviation of the current camera orientation and rotating the camera by these deviations by means of the electric motors. If a movement of the camera relative to its current position is additionally possible, for example by a slide running on rails, it can also be controlled such that a certain view of the area is achieved.

It is for example possible to automatically keep the player in the picture who is playing the ball in soccer, or the runner who is leading, or any other athlete.

Furthermore, the determined positional data can be used for stabilizing or improving video-based tracking (video tracking) of an athlete or a piece of sports equipment practiced up to now.

Here, for example the trajectories detected by the position detection systems are compared to the trajectories detected by video tracking and reassigned correctly in case of confusions. It is furthermore possible to determine those image regions where an athlete is located already before the image data are evaluated and to send them to the image processing unit, whereby the latter can already search the correct regions for contours of a person. It is thereby also achieved that in particular the relevant image regions are evaluated and can be analyzed at an increased rate compared to the normal image analysis.

Another possible use of the positional data is the recognition of game-typical actions. For example, in soccer or basketball, penalty kicks or free throws can be for example easily identified by the position of the ball or the person performing the penalty kick or the free throw. For this, typical features of actions are stored in the database, for example two players in an 18-yard box and the ball at the penalty kick point for a penalty kick situation. In the evaluation unit, the current positional data are compared to the stored features and thus game-typical actions are recognized.

Furthermore, the velocity and acceleration of the athlete can be assessed from the positional data. This is in particular interesting because it can, for example, give the athlete information on whether he has to work on his maximum velocity or rather on his stamina and how he should optimally pace himself in a competition.

In skiing or snowboarding, for example, the driven trajectory and the number of driven bends to the right and left can be determined. Furthermore, the time between individual bends can be determined and used for comparing these data with the data of other athletes, or for identifying driving errors.

Although in the present description, an athlete is equipped with the position detection system, it is clear that the same method can also be applied to objects of other types or persons in other contexts than sports events.

For example, position detection by means of magnetic fields can also be used for determining the path of a person in a supermarket. For this, the carts can be for example equipped with active or passive position detection systems, preferably, however, with the described magnetic field based position detection system, as the latter is largely insensitive to concealing inevitably occurring in the supermarket.

Another possible application is the camera or illumination work in events such as in the theatre or concerts. For this, the actors or, musicians would be equipped, for example, with active or passive position detection systems, preferably, however, with the described magnetic field based position detection system, as this is insensitive to interfering parasitic inductions, such as artificial illumination or sound waves.

FIG. 5 shows a schematic representation of an athlete equipped with acceleration sensors according to a preferred embodiment of the present invention.

This aspect of the present invention is to be judged as separate invention. It can be combined with the aspects mentioned above or below, but can also be realized alone.

To permit an acceleration analysis of an athlete (100), here acceleration sensors (400) are attached to the extremities of the athlete (100) which forward their data to the evaluation unit carried along or the central evaluation unit (200). It is in particular possible to determine with high precision relative changes of position and velocity over short time intervals from the acceleration sensors by integrating the acceleration vector after the compensation of gravitational acceleration. As for the compensation of gravitational acceleration, the orientation of the acceleration sensor must be known, in addition, three-dimensional rotation rate sensors or sensors for measuring the earth's magnetic field are used, or as an alternative to this, the sensor is three-dimensionally retained such that an orientation relative to gravitational acceleration remains constant, for example by using a gyroscope.

It is thus, for example, possible in broad jump or high jump, or in sports such as gymnastics, to reconstruct an exact image of the movement and to derive recommendations to act from it. In case of high jump, this could be, for example, the information that the athlete pushes his legs upwards too early or too late.

As in many sports, not only the athlete, but also a piece of sports equipment is of high relevance, it is necessary to also analyze the movement of the piece of sports equipment and the interaction with the athlete.

Therefore, the piece of sports equipment, for example a ball, can be equipped with an RF-ID chip. The latter permits to follow a movement taking place near radio units emitting and receiving electromagnetic waves. The radio units can be installed, for example, in movable elements, such as pylons, or else in stationary elements, such as, for example, in the goal post.

Here, the identification of the transponder located in the ball is received by a radio receiver and forwarded to the central evaluation unit or the evaluation unit carried along. This signal can then be used, for example, for following the movement of the ball in the proximity of pylons and for thus detecting, for example, the crossing of a goal line which is delimited by means of two pylons. The received data can then be used by the central evaluation unit for determining the number of achieved goals.

If the range of the RF-ID chip is not sufficient, the ball can be equipped, as an alternative to the RF-ID chip, with a three-dimensional magnetic field sensor. Here, for measuring the magnetic lines of force, a coil is preferably used. As an alternative, however, a Hall sensor, a magneto-resistive sensor, a Josephson contact, or the like can be used.

Preferably, the magnetic field in the center of the ball is measured with this. To ensure the non-vibrating placement of the magnetic field sensor exactly in the center of the ball, the magnetic field sensor can be positioned in the ball center by means of ropes.

As an alternative to the placement of the sensors in the middle of the ball, two magnetic field sensors are provided in a preferred embodiment.

FIG. 6 in this respect shows a schematic representation of a ball with two three-dimensional magnetic field sensors.

This aspect of the present invention is to be judged as separate invention. It can be combined with the aspects mentioned above or below, but it can also be realized alone.

The magnetic field sensors are fixed on opposite sides to the inner wall of the ball (500) according to FIG. 6. Here, both magnetic field sensors are cast into module disks (510), one module disk (510a) being attached at the valve and the other module disk (510b) being attached on the opposite side as a counterweight.

The measured values of both sensors are used for determining the measured value to be expected in the center of the ball (500). In case of the magnetizing force, this can be done, for example, by simple averaging.

Both module disks (510) are connected with flexible boards. The module disk (510a) at the valve carries, in addition to the magnetic field sensor, a radio transmitter with an antenna and a CPU. The accumulator (520) is seated on the opposite module disk (510b) and is attached such that it is lying on the side showing the ball.

To mitigate high accelerations, both module disks are seated on rubber naps (530) which absorb the major part of the pulse.

This configuration can also be used in an American football. There, the data of the two sensors could be additionally used for determining the orientation of the ball.

The magnetic field sensor or sensors are used for determining the position of the ball on the playing field by measuring the magnetic fields generated by several coils and sending the measured values to the central evaluation unit. Transmission can be accomplished as required in real time or after intermediate storage in the ball upon a request signal of the central evaluation unit.

The magnetic field can be generated either by magnetic field coils stationarily installed in the playing field or on the sidelines, or by a mobile construction consisting of magnetic field coils installed in a mat or in pylons. The position detection is then performed analogously to the above-described methods of the position detection of an athlete.

One can then calculate, for example, the trajectory, the velocity and the acceleration of the ball from the positional data.

Furthermore, an RF-ID chip or a coil installed in the ball can also be used for detecting ball contacts of an athlete.

Here, for example an electromagnetic signal source, preferably a radio transmitter, is attached to the athlete. The signals emitted by the radio transmitter excite the transponder installed in the ball, whereupon the same emits signals itself. The received transponder signal is either forwarded to the evaluation unit carried along or, together with an unambiguous identification of the athlete, to the central evaluation unit.

As an alternative, the athlete is equipped with a magnet coil which generates a magnetic field of a certain frequency. The magnetic field coil can be attached, for example, to the shin guard of a soccer player. The magnetic field can be detected by the magnetic field sensor installed in the ball. The distance can be calculated from the measured magnetizing force. An unambiguous identification of the coil can be determined from the specific frequency of the magnetic field. Both information are either stored in the ball or forwarded to the central evaluation unit.

With this, it can be detected, for example, which player has shot the ball.

Another possibility is to equip the athlete with a short-range radio transmitter which transmits a clear identification to the ball. The identification can be either stored by the ball or directly forwarded to the evaluation unit, so that ball contacts can be associated to an athlete.

Furthermore, the ball can be equipped with a pressure sensor which permits the activation of the magnetic field sensors located in the ball, for example by pressing the ball several times. Furthermore, the pressure sensor can be used for checking the air pressure within the ball during the course of the game, and for emitting an acoustic or optical warning signal if the ideal air pressure is fallen below.

The application of pressure sensors is also advantageous in other pieces of sports equipment, for example in sticks as they are used, for example, in ice hockey, or baseball bats.

FIG. 7 shows a schematic representation of a piece of sports equipment with pressure sensors according to a preferred embodiment of the present invention.

This aspect of the present invention is to be judged as separate invention. It can be combined with the aspects mentioned above or below, but it can also be realized alone.

Here, pressure sensors (610) installed in a hockey stick (600) are used for determining at which point a puck (620) touches the ice hockey stick (600) and with which pressure or which shooting force this contact was linked. These information are then forwarded to the evaluation unit carried along or the central evaluation unit. For forwarding the information, the ice hockey stick (600) is equipped with a radio module (630), the radio module (630) being connected to the pressure sensors by a cable.

Analogously, can be equipped with pressure sensors. Here, too, the position at which the ball touches the baseball bat or the shoe, respectively, as well as the pressure occurring in the process is forwarded to the evaluation unit carried along or the central evaluation unit.

After the trajectory of the puck or ball has been transmitted to the central evaluation unit by means of an above-described position detection method, the central evaluation unit can give feedback saying where the stick or the shoe would have had to touch the puck or the ball to achieve an optimal trajectory. This optimal point of contact is then shown for example in the form of LEDs (640) at the stick (600) or the shoe, respectively, or on a display of the evaluation unit carried along.

For this, for example the deviation of the determined trajectory of the ball or puck from an optimal trajectory is calculated, and the influence of the point of contact and the pulse transmission on the trajectory of the puck or the ball is determined. An optimal point of contact and an optimal pulse transmission are then calculated from these data and displayed as recommendation to act on the piece of sports equipment or the evaluation unit carried along.

An analogous method is also advantageous in sports such as basketball, where the ball is often thrown into the basket with the aid of the board. If the position of the athlete and/or the ball is known from one of the above-described position detection methods, an optimal trajectory of the ball can be calculated and shown to the athlete in the form of regions on the board marked by means of crystalline liquid or LEDs.

FIG. 8 shows a schematic representation of a piece of sports equipment with an indication of an area to be hit according to a preferred embodiment of the present invention.

This aspect of the present invention is to be judged as separate invention. It can be combined with the aspects mentioned above or below, but it can also be realized alone.

Here, a basketball board (700) is equipped with several LEDs (710) and a radio receiver unit (720). If the player (100) is standing with the ball (500) near the basketball board (700), the position of the ball (500) is determined by means of one of the above-described methods. From the position, the evaluation unit (200) calculates which region of the basketball board (700) must be hit to throw a basket. This region is displayed by LEDs (710), by which the player sees where the ball has to touch the board.

To transmit the region to be displayed, radio, for example 2.4-GHz band, can be employed.

To supply the sensors and the radio unit with energy to transmit the measured data to the evaluation unit carried along or the central evaluation unit, the piece of sports equipment is equipped with a battery. As an alternative, an accumulator can be used which can be recharged by way of an induction coil. If piezo-pressure sensors are used, it is also possible to use the electromagnetic voltage arising by the pressure for signal transmission.

As required, the evaluation unit carried along can be designed e.g. as portable minicomputer, as a mobile phone equipped with special software, or as PDA, while the central evaluation unit is typically designed as laptop or PC.

The central evaluation unit is adapted to combine all measured data and represent them in a form similar to a computer game.

FIG. 9 shows a schematic representation of a display on a central evaluation unit according to a preferred embodiment of the present invention.

Here, an image of a sports event is represented in the form of animated characters (800) which move over the virtual sports venue (900) like the corresponding real athletes (100).

Here, an athlete (810) can be selected at any time, whereupon further data are made available. These can be, in particular, data about movement patterns, such as, for example, the run track, jump distance, velocity, or else the acceleration of the movement or individual limbs or interaction patterns, such as for example the shot or throw of a ball, puck or any other piece of sports equipment.

It is furthermore possible to compare the calculated movement or interaction pattern with stored movement or interaction patterns and to represent deviations on the display of the evaluation unit. The deviations of the interaction patterns can in particular show differences in the shot or throw strength as well as different points of contact between, for example, the shoe and the ball, or the bat or stick and the ball or puck. Furthermore, the difference of the number of contacts between the athlete and the piece of sports equipment can be also displayed.

The present information can be furthermore utilized for feeding a computer game with performance data of the athletes to thus equip the characters with real data and make them thus appear more real and increase the pleasure to play. For this, the gathered data are sent to a computer which stores the data in a database. The data in the database can then be utilized by a computer game for determining the abilities of virtual athletes provided in the computer game. Furthermore, the data can be utilized for determining the possibility of interaction between the athlete and one or several pieces of sports equipment.

1. System, consisting of
at least one active or passive position detection system which sends data about the position of at least one athlete to a central evaluation unit; and
a central evaluation unit which stores received positional data in a database, automatically calculates a movement pattern consisting of at least the covered distance and the mean velocity from the positional data, and represents the movement pattern on a display.

2. System according to claim 1, wherein the evaluation unit compares the calculated movement pattern with stored movement patterns and represents deviations on the display.

3. System according to claim 1, in which, in addition to the positional data of the athlete, positional data of a piece of sports equipment are transmitted to the central evaluation unit using at least one passive position detection system, and in which the evaluation unit stores the received positional data in a database and calculates an interaction pattern between the piece of sports equipment and the athlete from the received positional data and represents the interaction pattern on the display.

4. System according to claim 3, wherein the evaluation unit compares the calculated interaction pattern with interaction patterns stored in the database and represents deviations on the display.

5. System according to claim 1 or 3, wherein the evaluation unit sends the calculated data to a computer which stores the data in a database of a computer game to thus determine the abilities of virtual athletes provided in the computer game or their interaction patterns with pieces of sports equipment.

6. System according to claim 1, wherein the position detection of an athlete is determined by means of several sensors attached on the sidelines of a sports venue, the sensors measuring the ultrasonic sound intensity and/or the infrared light intensity of signal sources attached to at least one athlete and sending these data to the central evaluation unit which calculates the position of the athlete from the known interrelationship between the radial decrease of the sound intensity and/or luminous intensity.

7. System according to claim 1 or 3, wherein the position of the athlete or the piece of sports equipment is determined by means of at least one magnetic field sensor attached to an athlete or to a piece of sports equipment which sends data about the alternating magnetic fields generated by at least two magnetic field coils to an evaluation unit carried along or to the central evaluation unit which either solves the magnetic field equation or uses the interrelationship between the decrease of the magnetic field strength and the radial distance between the magnetic field sensor and the magnetic field coil.

8. System according to claim 6 or 7, wherein the positional data about the athlete and/or the piece of sports equipment are used for directing a camera to a desired region.

9. System according to claim 8, wherein an image processing unit only analyses individual regions of an image on the basis of the positional data about the athlete and/or the piece of sports equipment, but analyses these regions with a higher frame rate than the normal frame rate.

10. System according to claim 3, wherein the athlete and/or the piece of sports equipment is equipped with an acceleration sensor, and the data of the acceleration sensor of the athlete are integrated on an evaluation unit carried along or a central evaluation unit, and the data of the acceleration sensor of the piece of sports equipment are integrated on the central evaluation unit and used for improving positional data and/or velocity data.

11. System according to claim 3, wherein the piece of sports equipment is a ball or a puck, and a shoe or a stick is additionally equipped with at least one pressure sensor which sends the data of the pressure sensors to the evaluation unit carried along or the central evaluation unit, which uses the data of the pressure sensor and the positional data of the ball for supplying the athlete with feedback indicating how he has to change his technique to achieve a desired trajectory of the ball or the puck.

12. Method of displaying performance data of at least one athlete, consisting of the procedure steps of
sending data about the position of at least one athlete to a central evaluation unit;
storing the received data in a database;
calculating at least one movement pattern from the positional data, consisting of at least the covered distance and the mean velocity of an athlete; and
displaying the calculated movement pattern on a display of the evaluation unit.

13. Method according to claim 12, with the further procedure steps of
comparing the calculated movement pattern with at least one further movement pattern, and
displaying the deviations on the display.

14. Method according to claim 12, with the further procedure steps of
sending positional data of a piece of sports equipment to the central evaluation unit;
calculating an interaction pattern between the piece of sports equipment and the athlete; and
displaying the calculated interaction pattern on the display.

15. Method according to claim 14, with the further procedure steps of
comparing the calculated movement pattern with at least one further movement pattern, and
displaying the deviations on the display.

16. Method according to claim 12, with the further procedure steps of
sending the calculated data to a computer;
storing the received data in a database;
determining the abilities of virtual athletes provided in a computer game or their interaction patterns with pieces of sports equipment.

17. Method according to claim 12, wherein the position of an athlete is determined by means of several sensors attached on the sidelines of a sports venue, the sensors measuring the ultrasonic sound intensity and/or the infrared light intensity of signal sources attached to at least one athlete and sending these data to the central evaluation unit which calculates the position of the athlete from the known interrelationship between the radial decrease of the sound intensity and/or luminous intensity.

18. Method according to claim 12 or 14, wherein the position of the athlete or the piece of sports equipment is determined by means of at least one magnetic field sensor attached to the athlete or the piece of sports equipment which sends data about the alternating magnetic fields generated by at least two magnetic field coils to the central evaluation unit which either solves the magnetic field equation or uses the interrelationship between the decrease of the magnetic field strength and the radial distance between the magnetic field sensor and the magnetic field coil.

19. Method according to claim 17 or 18 with the further procedure step of
directing a camera to a region given by the positional data about the athlete and/or the piece of sports equipment.

20. Method according to claim 19, wherein an image processing unit only analyses individual regions of an image on the basis of the positional data about the athlete and/or the piece of sports equipment, but analyses these regions with a higher frame rate than the normal frame rate.

21. Method according to claim 12, with the further procedure steps of
emitting the data of one or several acceleration sensors attached to the athlete and/or to the piece of sports equipment;
integrating the data on an evaluation unit carried along or a central evaluation unit;
fusion of the positional data and/or the velocity data with positional data of at least one other system by means of a Kalman filter.

22. Method according to claim 14, wherein the piece of sports equipment is a ball or a puck, and a shoe or a stick is additionally equipped with at least one pressure sensor, with the further procedure steps of
sending the data to the evaluation unit carried along or the central evaluation unit;
calculating the deviation of the determined trajectory of the ball or the puck from an optimal trajectory;
determining the influence of the point of contact and the pulse transmission on the trajectory of the puck or the ball;
calculating an optimal point of contact and an optimal pulse transmission;
displaying a recommendation to act derived from the calculated data on the piece of sports equipment or the evaluation unit carried along.

23. System for detecting the position of an athlete, consisting of
several sensors attached on the sidelines of a sports venue which measure the ultrasonic sound intensity and/or the infrared light intensity of signal sources attached to at least one athlete and send these data to a central evaluation unit which calculates the position of the athlete from the known interrelationship between the radial decrease of the sound intensity and/or luminous intensity.

24. System for detecting the position of a person or an object, consisting of
at least one magnetic field sensor attached to a person or an object which sends data about the alternating magnetic fields generated by at least two magnetic field coils to an evaluation unit carried along or a central evaluation unit, which either solves the magnetic field equation or uses the interrelationship between the decrease of the magnetic field strength and the radial distance between the magnetic field sensor and the magnetic field coil to detect the position of the magnetic field sensor.

25. System according to claim 23 or 24, wherein the positional data about a person and/or an object are used for directing a camera to a desired region.

26. System according to claim 25, wherein an image processing unit only analyses individual regions of an image on the basis of the positional data about a person and/or an object, but analyses these regions with a higher frame rate than the normal frame rate.

27. System for determining the velocity and position of an athlete and/or a piece of sports equipment, consisting of
an acceleration sensor provided at the athlete and/or at the piece of sports equipment which sends its data to an evaluation unit carried along or a central evaluation unit where the data are integrated to obtain velocity and position information about the movement of the athlete and/or the piece of sports equipment.

28. System according to claim 24, wherein the object is a ball or a puck, and a shoe or a stick is additionally equipped with at least one pressure sensor which sends the data of the pressure sensors to the evaluation unit carried along or the central evaluation unit, which use the data of the pressure sensors and the positional data of the ball for supplying the athlete with feedback indicating how he has to change his technique to achieve a desired trajectory of the ball or the puck.
